(19) United States
(12) Patent Application Publication
(10) Pub. No.: US 2007/0162389 A1
(43) Pub. Date: Jul. 12, 2007

(54) Method and system for automated teller machine online/offline operation

(75) Inventors: Andrew Hamilton, Dundee (GB); Stephen Neil MacPhail, Dundee (GB); Wolf Rossmann, Forfar (GB)

Correspondence Address: JAMES M. STOVER;NCR CORPORATION, 1700 SOUTH PATTERSON BLVD, WHQ4, DAYTON, OH, 45479, US

(73) Assignee: NCR Corporation, Dayton, OH (US)

(21) Appl. No.: 11/328,324

(22) Filed: Jan. 9, 2006

(51) Int. Cl. G06Q 40/00

(52) U.S. Cl. 705/43

(57) ABSTRACT

Methods, systems, and software are disclosed for configuring an ATM. The ATM receives an online/offline configuration message that specifies one or more conditions when the ATM is to go online. The ATM goes offline and performing zero or more offline transactions. The ATM goes online based at least in part on at least a portion of the online/offline configuration message. The online/offline configuration message is in an XML-based format.

### CROSS-REFERENCE TO RELATED APPLICATION

This application claims priority to commonly owned U.S. provisional patent application, NCR Docket No. 12412, filed Dec. 26, 2005, entitled “Method and System for Automated Teller Machine Online/Offline Operation,” by Andrew Hamilton, Wolf Rossmann, and Stephen MacPhail.

### BACKGROUND

Automated teller machines (sometimes abbreviated as ATMs) can be configured to allow users to perform various financial transactions at any time. For example, many banks have one or more ATMs from which users may withdraw cash from a checking or savings account that corresponds to a card provided by the user. ATMs can also include devices called financial self-service terminals and kiosks. ATMs can perform one or more of a large number of customer transactions in addition to simply withdrawing cash such as depositing cash or checks in an account, checking the balance in an account, and transferring funds between accounts. ATMs can also perform one or more of a large number of administrative transactions including updating ATM software and replenishing the cash supply of the ATM.

Within the context of an ATM transaction, the financial institution that operates the ATM may be referred to as the acquiring institution or acquiring bank. The financial institution that holds the account of the ATM user and issues the ATM card to the user may be referred to as the issuing institution or issuing bank.

ATMs may be connected to a host computer of the acquiring institution by communications links. The communications links may be non-persistent, requiring the ATM to reinitiate communications with the host computer of the acquiring institution. The communications links may be persistent, requiring dedicated bandwidth.

### SUMMARY

In general, in one aspect, the invention features a method for a method for operating an ATM. The ATM receives an online/offline configuration message. The online/offline configuration message specifies one or more conditions when the ATM is to go online. The ATM goes offline and performs zero or more offline transactions. The ATM goes online based at least in part on at least a portion of the online/offline configuration message. The online/offline configuration message is in an XML-based format.

In general, in another aspect, the invention features a system for operating an ATM. The system includes an ATM configured to receive an online/offline configuration messages, go offline, perform zero or more offline transactions, and go online based at least in part on at least a portion of the online/offline configuration message. The online/offline configuration message specifies one or more conditions when the ATM is to go online. The system includes a non-persistent communication link coupled to the ATM and a computer coupled to the non-persistent communication link. The ATM is configured to receive the online/offline configuration message in an XML-based format.

In general, in another aspect, the invention features computer software, stored on a tangible storage medium, for configuring the online/offline operation of an ATM. The software includes executable instructions that cause at least one computer to receive an online/offline configuration message at an ATM, where the online/offline configuration message specifies one or more conditions when the ATM is to go online. The instruction cause the at least one computer to going offline and perform zero or more offline transactions, and go online based at least in part on at least a portion of the online/offline configuration message. The online/offline configuration message is in an XML-based format.

### BRIEF DESCRIPTION OF THE DRAWINGS

FIG. 1 is a diagram of a system for operating an ATM according to one exemplary embodiment.

FIG. 2 is a diagram of a system for operating an ATM according to one exemplary embodiment.

FIGS. 3-4 are flow charts of a method for configuring the online/offline behavior of an ATM according to one exemplary embodiment.

FIG. 5 is a data diagram for an ATM online/offline configuration message represented in an XML-based format according to one exemplary embodiment.

### DETAILED DESCRIPTION

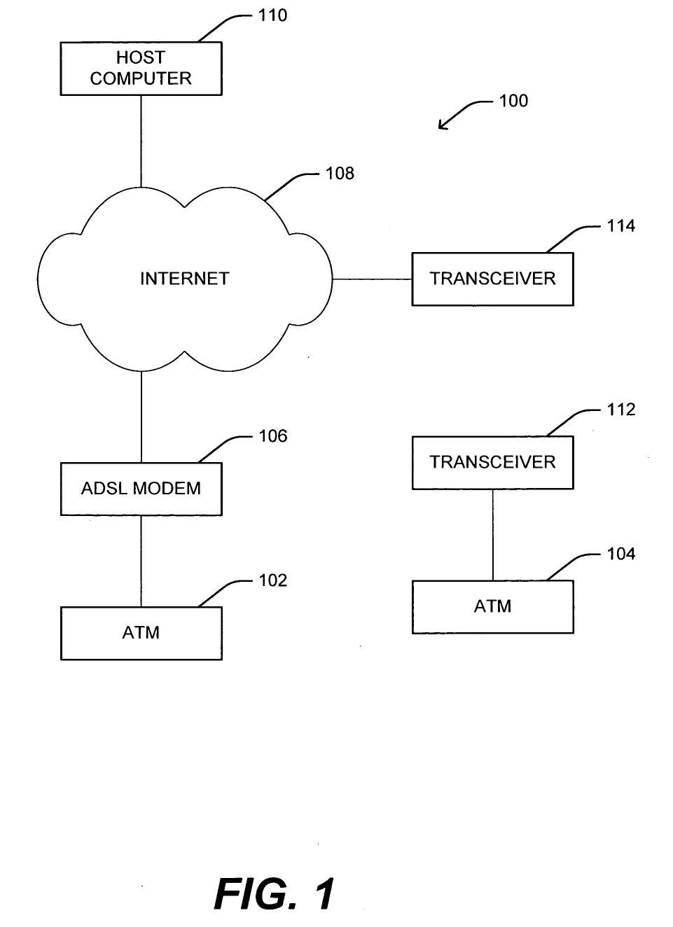

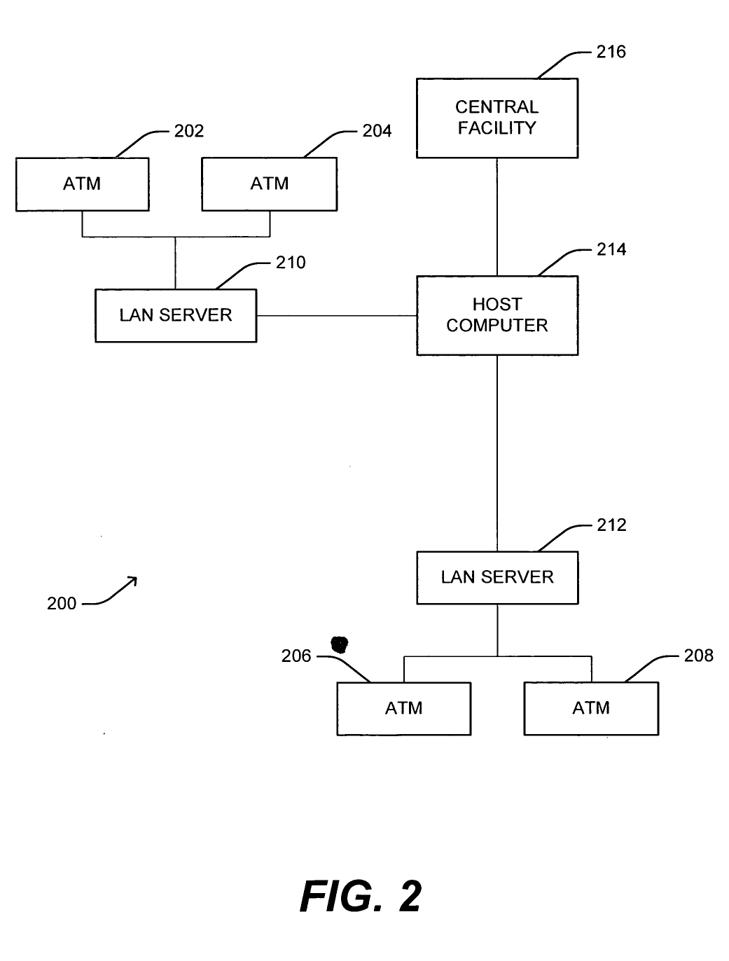

The ATM online/offline operation technique disclosed herein has particular application, but is not limited, to groups of ATMs that are networked together for central administration. FIGS. 1 and 2 illustrate different embodiments of system configurations for operating ATMs in a manner that provides online/offline operations. Those systems are exemplary and many different systems for coupled a computer to a ATM using a communications link can be utilized with various communications technologies.

In FIG. 1, the system 100 includes two ATMs 102, 104, each with a communications link to a host computer 110. In the FIG. 1 embodiment, the host computer is coupled to the Internet 108. ATM 102 communicates with a computer in the Internet 108 over an Asymmetric Digital Subscriber Line (ADSL) using an ADSL modem 106. ATM 104 communicates with a computer in the Internet 108 over a wireless connection established by two transceivers 112, 114 that exchange electromagnetic waves that are modified in a predetermined manner to indicate information. While ATMs 102, 104 may have different data transfer rates, each is coupled to the host computer 110 through a communications link that includes the Internet 108.

In FIG. 2, the system 200 includes four ATMs 202, 204, 206, 208 which are organized into two groups of two. Each group of ATMs is associated with a LAN server 210, 212 (LAN is an acronym for Local Area Network). System 200 can be used when multiple ATMs are associated with particular physical locations. For example, a bank or a shopping mall may have two or more ATMs. The first group of ATMs 202, 204 are coupled to LAN server 210. As one example, the ATMs 202, 204 can use an ethernet protocol (such as Ethernet, 100Base-T, or Gigabit Ethernet) and architecture to route messages to and from the LAN server 210. Other LAN protocols and architectures can also be used. The second group of ATMs 206, 208 are couple to LAN server 212. The LAN servers 210, 212 are coupled to the host computer 214, for example in a Wide Area Network (WAN). The communications between the LAN servers 210, 212 and the host computer 214 can travel through a public network such as the telephone system or the Internet. The communications between the LAN servers 210, 212 and the host computer 214 can also travel through private telecommunications devices such as a leased line or a satellite. While system 200 shows only two LAN servers 210, 212, additional LANs with two or more ATMs could be added. For example, a banking company may have hundreds of branches with each branch including one or more ATMs that are connected to a LAN for that branch. A LAN server employed with a particular bank branch can be called a branch controller. The LAN need not be dedicated to the ATMs. For example, computers used by branch employees may also be connected to the LAN and the WAN to send and receive information. As an alternative embodiment, the ATMs 202, 204 may only send information to the LAN server 210 and not to the host computer 214. An employee of the branch with LAN server 210 can then determine whether to send a group of ATM communications on to the host computer 214 or an automatic process can be performed, for example at the end of the day. A central facility 216 can also be provided to store information received from the ATMs. For example, the host computer 214 can store information received from the ATMs 202, 204, 206, 208 for a set time period and forward older information to be stored at the central facility 216.

While FIGS. 1 and 2 illustrate particular network configurations, many other configurations are possible. For example, a single ATM may communicate with a single computer through a dial-up link. In other words, the ATM establishes a call only as part of the process for sending a message and does not maintain the call at other times. Such a call can occur over a copper wire connection or using a wireless connection established by a mobile phone as two examples. In addition, many different communications protocols can be used to encode information transmitted from the ATM(s), including but not limited to Transmission Control Protocol/Internet Protocol (TCP/IP), Synchronous Optical NETwork (SONET), and Code Division Multiple Access (CDMA). The information transmitted using these protocols can be compressed prior to transmission using, for example, one of several known compression techniques. The communications hardware includes but not limited to electrical wires or cables, optical cables, and wireless transmitters and receivers.

In one embodiment, the ATMs shown in FIGS. 1 and 2 are accessible by customers for customer transactions. The ATMs can include buttons, a card scanner, or a touch-sensitive screen by which the ATM receive instructions and information from a customer. One example ATM may have a card reader, a screen, a group of number keys, and a group of buttons next to the screen. The ATM is programmed to have a transaction ready state where a customer can initiate a transaction by presenting a card that includes card information to the card reader. Certain example cards store card information on a magnetic stripe. Other example cards, such as smart cards, store card using on-card circuitry. The ATM can read the information on the card. The ATM can then display a request for a code to be entered using the number keys. The ATM can then wait a predetermined amount of time to receive the code. Certain example cards include circuitry that allows the ATM to locally authenticate the user, without contacting a computer host, such as computer host 110. Other example cards require that the code be remotely authenticated, for example, by contacting the issuing institution to verity the code. If the correct code is entered, the ATM can then provide options with a graphical indication of the button that corresponds to each option to guide the customer through a transaction. The example ATM with these structures is configured to allow customer transactions in which the ATM both displays information to the customer and receives information from the customer. The same structures can be used to perform administrative transactions. For example, a particular magnetic card and code can be used to initiate a transaction by a bank employee who inserted cash to replenish the ATM.

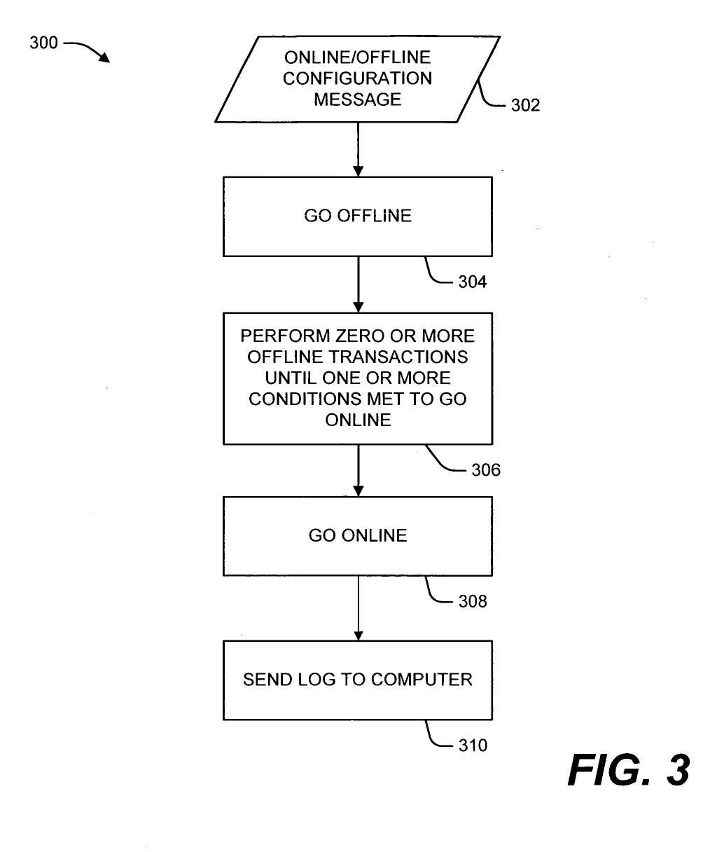

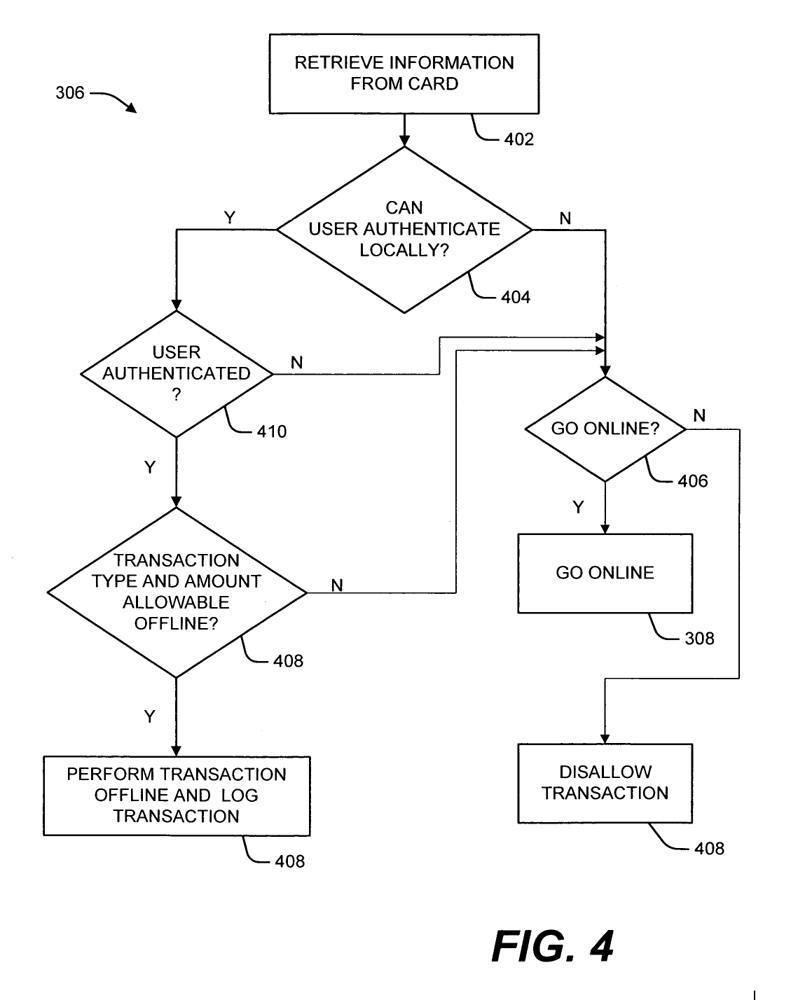

FIG. 3 is a flowchart showing an example method for operating an ATM in an offline mode and an online mode. The ATM receives an online/offline configuration message (block 302). In general, the online/offline configuration message specifies zero or more conditions when the ATM is to go offline and one or more conditions when the ATM is to go back online. In certain implementations, the online/offline configuration message may specify that the ATM is to go offline immediately. In other implementations, the online/offline configuration message may specify one or more conditions when the ATM is to go offline, which may include going offline at a specified time or based on the occurrence of one or more other conditions. The one or more conditions when the ATM is to go online may include, for example going online at one or more specified times. After receiving the online/offline configuration message (block 305), the ATM goes offline (block 304). While offline, the ATM performs zero or more offline transactions until one or more conditions to go back online are met (block 306, which is shown in greater detail in FIG. 4). The ATM goes online (block 308), and send a log of the zero or more offline transactions to a computer, such as host computer 110 (block 310).

An example method for performing zero or more offline transactions until one or more conditions are met to go online (block 306), is shown in FIG. 4. A user presents a card to the ATM (not shown). The ATM receives information from the card (block 402), and determines if the user can authenticate locally (block 404). In certain example implementations, this condition is met where the user presents a card with embedded logic which allows the ATM to verify the user's PIN without having to contact a remote computer, such as remote host 110. If the user cannot authenticate locally (block 404), then the ATM determine whether to go online based on this condition (block 406), and if so the ATM goes online (block 308), otherwise the ATM does not allow the transaction to proceed (block 408).

If the user can authenticate locally (block 404), then the ATM attempts to authenticate the user. If the user cannot authenticate, the ATM proceeds to block 406. If the user has authenticated, then the ATM determine if a transaction type selected by the user can be performed offline. If the transaction type selected by the user cannot be performed offline, then the ATM proceeds to block 406, where it determines whether to go online based on the condition. If the transaction can be performed offline, then the ATM performs the transaction offline and logs the transaction (block 408).

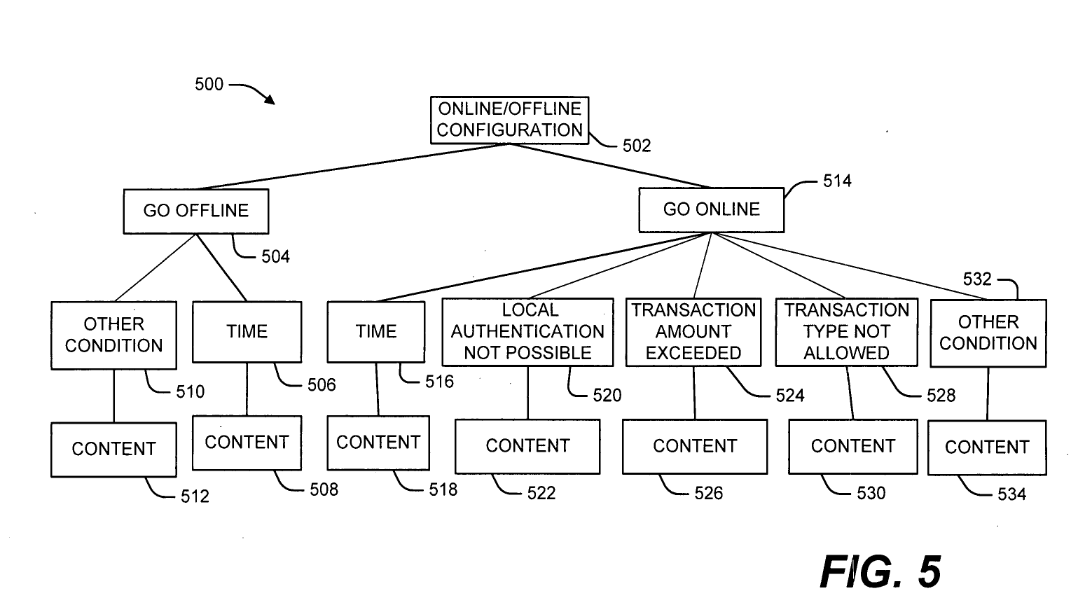

FIG. 5 shows an example data structure 500 of an online/offline configuration message received by the ATM at block 302. The message information is stored in nested tags. Each of the tags can include data and/or tags contained within it. The top level tag is an online/offline configuration tag 502. The online/offline configuration tag 502 includes a go offline tag. In general, the go offline tag 502 may include zero or more tags to specify when to go offline. In other implementations, the online/offline configuration tag 502 may not include a go offline tag 504. The go offline tag 504 includes a time tag 506 with content 508 specifying when the ATM is to go offline. The content 508 may specify one or more of a date and a time of day to go offline. The go offline tag 504 also includes an other condition tag 510 with content 512 specifying when the ATM is to go offline. In certain implementations, the conditions to go offline may depend of hardware limitations, such as communications link limitations, or business conditions.

The online/offline configuration tag 502 includes a go online tag 514. The go online tag 514, in turn, includes a time tag 516 with content 518 that specifies when the ATM is to go online. In general, the go online tag includes one or more tags to specify conditions when the ATM should go online. The go online tag 514 includes a local authentication not possible tag 520 with content 522 to specify whether to ATM is to go back online if the user attempts to conduct a transaction at the ATM with a card that cannot authenticate the user, or if the user cannot authenticate with such a card. The go online tag 514 includes a transaction amount exceeded tag 514 with content 526 to specify whether the ATM will go online if a maximum transaction amount is exceeded while offline. The go online tag 514 includes a transaction type not allowed tag 528 with content 530 to specify whether the ATM will go online if the user attempts to perform a transaction type that is not allowed while the ATM is offline. The go online tag 514 includes an other condition tag 532 and content 534 to specify one or more other conditions when the ATM will go online if the condition occurs.

In certain implementations, the online/offline configuration of the ATM is stored by the ATM as part of a logical object.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for operating an automated teller machine (ATM), comprising:
receiving an online/offline configuration message at an ATM, where the online/offline configuration message specifies one or more conditions when the ATM is to go online;
going offline;
performing zero or more offline transactions; and
going online based at least in part on at least a portion of the online/offline configuration message,
wherein the online/offline configuration message is in an XML-based format.

2. The method of claim 1, further comprising:
storing a log of the offline transactions; and
sending the log to a computer after going online.

3. The method of claim 1, where one or more of the one or more conditions when the ATM is to go online is a time to go online, and where going online based at least in part on at least a portion of the one or more configuration online/offline configuration messages comprises:
going online at the time to go online.

4. The method of claim 1, where performing zero or more offline transactions, further comprises:
receiving information from a user's card; and
determining if the user can authenticate locally, and if so:
attempting to authenticate the user locally, and if successful:
allowing the user to perform an offline transaction.

5. The method of claim 1, where one or more of the one or more conditions when the ATM is to go online is when a user attempts to use a card that is not configured to authenticate the user, and where going online based at least in part on at least a portion of the one or more configuration online/offline configuration messages comprises:
receiving information from a user's card; and
determining if the user can authenticate locally, and if not:
going online.

6. The method of claim 1, where performing zero or more offline transactions, further comprises:
only allowing offline transactions where a transaction amount is below a maximum offline transaction amount.

7. The method of claim 1, where performing zero or more offline transactions, further comprises:
only allowing offline transactions where a transaction type is an allowed offline transaction type.

8. A system for operating an automated teller machine (ATM), comprising:
an ATM configured to receive an online/offline configuration messages, go offline, perform zero or more offline transactions, and go online based at least in part on at least a portion of the online/offline configuration message, where the online/offline configuration message specifies one or more conditions when the ATM is to go online;
a non-persistent communication link coupled to the ATM; and
a computer coupled to the non-persistent communication link,
wherein the ATM is configured to receive the online/offline configuration message in an XML-based format.

9. The system of claim 8, where the ATM is further configured to:
store a log of the offline transactions; and
send the log to a computer after going online.

10. The system of claim 8, where one or more of the one or more conditions when the ATM is to go online is a time to go online, and where the ATM is further configured to go online at the time to go online.

11. The system of claim 8, where the ATM is further configured to:
receive information from a user's card; and
determine if the user can authenticate locally, and if so:
attempt to authenticate the user locally, and if successful:
allow the user to perform an offline transaction.

12. The system of claim 8, where one or more of the one or more conditions when the ATM is to go online is when a user attempts to use a card that is not configured to authenticate the user, and where the ATM is further configured to:
receive information from a user's card; and
determine if the user can authenticate locally, and if not:
go online.

13. The system of claim 8, where the ATM is further configured to:
only allow offline transactions where a transaction amount is below a maximum offline transaction amount.

14. Computer software, stored on a tangible storage medium, for configuring the online/offline operation of an automated teller machine (ATM), the software comprising executable instructions that cause at least one computer to:
receive an online/offline configuration message at an ATM, where the online/offline configuration message specifies one or more conditions when the ATM is to go online;
going offline;
perform zero or more offline transactions; and
go online based at least in part on at least a portion of the online/offline configuration message,
wherein the online/offline configuration message is in an XML-based format.

15. The computer software of claim 14, further comprising instructions that cause the at least one computer to:
store a log of the offline transactions; and
send the log to a computer after going online.

16. The computer software of claim 14, where one or more of the one or more conditions when the ATM is to go online is a time to go online, and where the executable instructions that cause the ATM to go online based at least in part on at least a portion of the one or more configuration online/offline configuration messages further cause the at least one computer to:
go online at the time to go online.

17. The computer software of claim 14, where the executable instructions that cause the computer to perform zero or more offline transactions, further cause the at least one computer to:
receive information from a user's card; and
determine if the user can authenticate locally, and if so:
attempt to authenticate the user locally, and if successful:
allow the user to perform an offline transaction.

18. The computer software of claim 14, where one or more of the one or more conditions when the ATM is to go online is when a user attempts to use a card that is not configured to authenticate the user, and where the executable instructions that cause the at least one computer to go online based at least in part on at least a portion of the one or more configuration online/offline configuration messages further cause the at least one computer to:
receive information from a user's card; and
determine if the user can authenticate locally, and if not:
go online.

19. The computer software of claim 14, where the executable instructions that cause the at least one computer to perform zero or more offline transactions, further cause the at least one computer to:
only allow offline transactions where a transaction amount is below a maximum offline transaction amount.

20. The computer software of claim 14, where the executable instructions that cause the at least one computer to perform zero or more offline transactions, further cause the at least one computer to:
only allow offline transactions where a transaction type is an allowed offline transaction type.
